(19) United States
(12) Patent Application Publication
(10) Pub. No.: US 2025/0046087 A1
(43) Pub. Date: Feb. 6, 2025

(54) DISPLAY SYSTEM AND DISPLAY METHOD

(71) Applicant: Komatsu Ltd., Tokyo (JP)

(72) Inventors: Shun Kawamoto, Tokyo (JP); Tsubasa Hasumi, Tokyo (JP); Li Dong, Tokyo (JP)

(73) Assignee: Komatsu Ltd., Tokyo (JP)

(21) Appl. No.: 18/715,769

(22) PCT Filed: Dec. 7, 2022
(86) PCT No.: PCT/JP2022/045054

§ 371 Date: Jun. 3, 2024

(30) Foreign Application Priority Data
Dec. 10, 2021 (JP) 2021-201059

(51) Int. Cl. G06V 20/52; G06T 17/00; G06V 10/70; G06V 20/56; G06V 40/10

(52) U.S. Cl. CPC G06V 20/52; G06T 17/00; G06V 10/70; G06V 20/56; G06V 40/10

(57) ABSTRACT

A display system includes: a three-dimensional data storage unit that stores three-dimensional data indicating a three-dimensional shape in a first range of a construction site in which a work machine operates; a detection data acquisition unit that acquires detection data indicating a three-dimensional shape in a second range that is a part of the first range; an update unit that updates a partial range of the three-dimensional data on the basis of the detection data; and a display control unit that causes a display apparatus to display an updated range and a non-updated range in different display forms in the three-dimensional data.

### FIELD

The present disclosure relates to a display system and a display method.

### BACKGROUND

In a technical field related to construction management, a construction management system as disclosed in Patent Literature 1 is known.

### CITATION LIST

### Patent Literature

Patent Literature 1: WO 2019/012993 A

### SUMMARY

### Technical Problem

A situation of a construction site changes. For example, a situation of topography of the construction site changes in accordance with a progress of construction. In addition, operation of a work machine changes a situation of the work machine. There is a demand for a technique capable of appropriately confirming a situation of a construction site.

An object of the present disclosure is to confirm a situation of a construction site.

### Solution to Problem

According to an aspect of the present invention, a display system comprises: a three-dimensional data storage unit that stores three-dimensional data indicating a three-dimensional shape in a first range of a construction site in which a work machine operates; a detection data acquisition unit that acquires detection data indicating a three-dimensional shape in a second range that is a part of the first range; an update unit that updates a partial range of the three-dimensional data on the basis of the detection data; and a display control unit that causes a display apparatus to display an updated range and a non-updated range in different display forms in the three-dimensional data.

### Advantageous Effects of Invention

According to the present disclosure, it is possible to confirm a situation of a construction site.

### BRIEF DESCRIPTION OF DRAWINGS

FIG. 1 is a schematic view illustrating a construction management system according to an embodiment.

FIG. 2 is a view illustrating a flight vehicle according to the embodiment.

FIG. 3 is a functional block diagram illustrating a display system according to the embodiment.

FIG. 4 is a flowchart illustrating a display method according to the embodiment.

FIG. 5 is a diagram illustrating a relationship between a first range and a second range according to the embodiment.

FIG. 6 is a diagram illustrating a method for specifying an object according to the embodiment.

FIG. 7 is a view illustrating one example of a display apparatus according to the embodiment.

FIG. 8 is a diagram illustrating another example of the display apparatus according to the embodiment.

FIG. 9 is a diagram illustrating another example of the display apparatus according to the embodiment.

FIG. 10 is a diagram illustrating another example of the display apparatus according to the embodiment.

FIG. 11 is a block diagram illustrating a computer system according to the embodiment.

### DESCRIPTION OF EMBODIMENTS

Hereinafter, embodiments according to the present disclosure will be described with reference to the drawings, but the present disclosure is not limited to the embodiments. Components of the embodiments described below can be appropriately combined. In addition, some of the components may not be used.

### [Construction Management System]

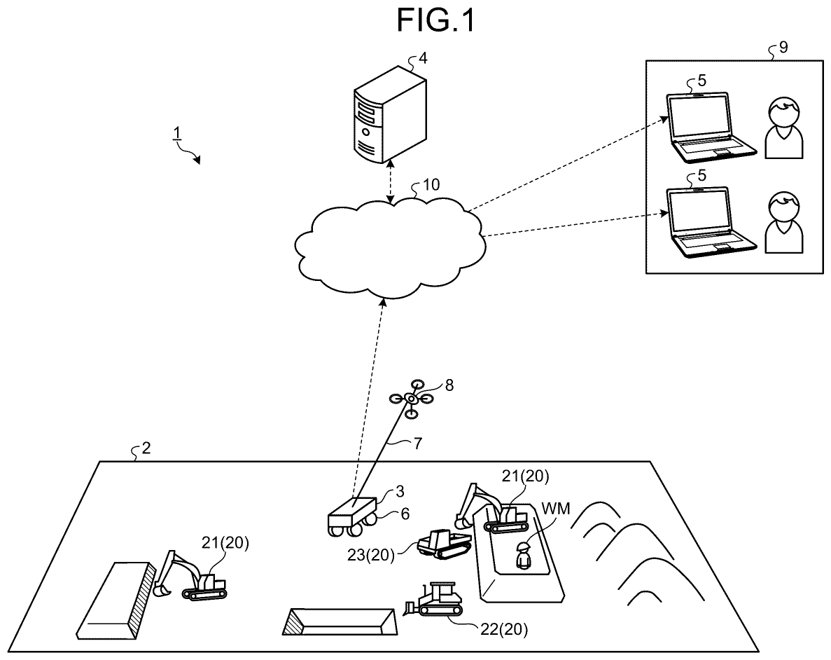

FIG. 1 is a schematic view illustrating a construction management system 1 according to an embodiment. The construction management system 1 manages construction in a construction site 2. A plurality of work machines 20 operate in the construction site 2. In the embodiment, the work machines 20 include a hydraulic excavator 21, a bulldozer 22, and a crawler dump 23. A person WM exists in the construction site 2. As the person WM, a worker who works in the construction site 2 is exemplified. Note that the person WM may be a supervisor who manages construction. The person WM may be a visitor.

As illustrated in FIG. 1, the construction management system 1 includes a management apparatus 3, a server 4, information terminal 5, and a flight vehicle 8.

The management apparatus 3 includes a computer system disposed in the construction site 2. The management apparatus 3 is supported by a traveling apparatus 6. The management apparatus 3 can travel the construction site 2 by the traveling apparatus 6. As the traveling apparatus 6, an aerial work platform vehicle, a truck, and a traveling robot are exemplified.

The server 4 includes a computer system. The server 4 may be disposed in the construction site 2 or may be disposed at a remote location of the construction site 2.

Each of the information terminals 5 is a computer system disposed in a remote location 9 of the construction site 2. As the information terminal 5, a personal computer and a smartphone are exemplified.

The management apparatus 3, the server 4, and the information terminals 5 communicate with each other via a communication system 10. As the communication system 10, the Internet, a local area network (LAN), a mobile phone communication network, and a satellite communication network are exemplified.

The flight vehicle 8 flies in the construction site 2. As the flight vehicle 8, an unmanned aerial vehicle (UAV) such as a drone is exemplified. In the embodiment, the flight vehicle 8 and the management apparatus 3 are connected by a cable 7. The management apparatus 3 includes a power source or a generator. The management apparatus 3 can supply a power to the flight vehicle 8 via the cable 7.

### [Flight Vehicle]

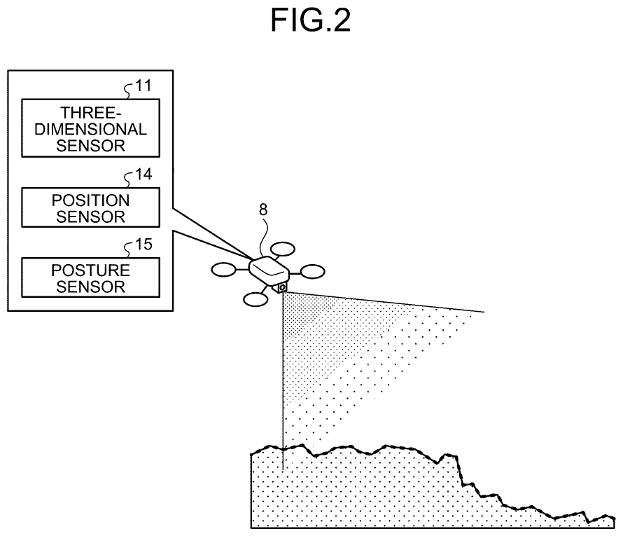

FIG. 2 is a view illustrating the flight vehicle 8 according to the embodiment. A three-dimensional sensor 11, a position sensor 14, and a posture sensor 15 are mounted on the flight vehicle 8.

The three-dimensional sensor 11 detects the construction site 2. The three-dimensional sensor 11 acquires three-dimensional data indicating a three-dimensional shape of the construction site 2. Detection data of the three-dimensional sensor 11 includes the three-dimensional data of the construction site 2. The three-dimensional sensor 11 is disposed in the flight vehicle 8. The three-dimensional sensor 11 detects the construction site 2 from above the construction site 2. As a detection target of the three-dimensional sensor 11, topography of the construction site 2 and an object existing in the construction site 2 are exemplified. The object includes one or both of a movable body and a stationary body. As the movable body, the work machine 20 and the person WM are exemplified. As the stationary body, construction tools, wood, and materials are exemplified.

The detection data of the three-dimensional sensor 11 includes image data indicating an image of the construction site 2. The image data acquired by the three-dimensional sensor 11 may be moving image data or still image data. As the three-dimensional sensor 11, a stereo camera is exemplified. Note that the three-dimensional sensor 11 may include a monocular camera and a three-dimensional measurement apparatus. As the three-dimensional measurement apparatus, a laser sensor (light detection and ranging (LIDAR)) that detects a detection target by emitting a laser beam is exemplified. Note that the three-dimensional measurement apparatus may be an infrared sensor that detects an object by emitting infrared light or a radar sensor (radio detection and ranging (RADAR)) that detects the object by emitting radio waves.

The position sensor 14 detects a position of the flight vehicle 8. The position sensor 14 detects the position of the flight vehicle 8 using a global navigation satellite system (GNSS). The position sensor 14 includes a GNSS receiver (GNSS sensor), and detects a position in a global coordinate system of the flight vehicle 8. The three-dimensional sensor 11 is fixed to the flight vehicle 8. The position sensor 14 can detect s position of the three-dimensional sensor 11 by detecting the position of the flight vehicle 8. Detection data of the position sensor 14 includes position data of the three-dimensional sensor 11.

The posture sensor 15 detects a posture of the flight vehicle 8. The posture includes, for example, a roll angle, a pitch angle, and a yaw angle. As the posture sensor 15, an inertial measurement unit (IMU) is exemplified. The three-dimensional sensor 11 is fixed to the flight vehicle 8. The posture sensor 15 can detect a posture of the three-dimensional sensor 11 by detecting the posture of the flight vehicle 8. Detection data of the posture sensor 15 includes posture data of the three-dimensional sensor 11.

Each of the detection data of the three-dimensional sensor 11, the detection data of the position sensor 14, and the detection data of the posture sensor 15 is transmitted to the management apparatus 3 via the cable 7. Each of the detection data of the three-dimensional sensor 11, the detection data of the position sensor 14, and the detection data of the posture sensor 15, which are received by the management apparatus 3, is transmitted to the server 4 via the communication system 10.

### [Display System]

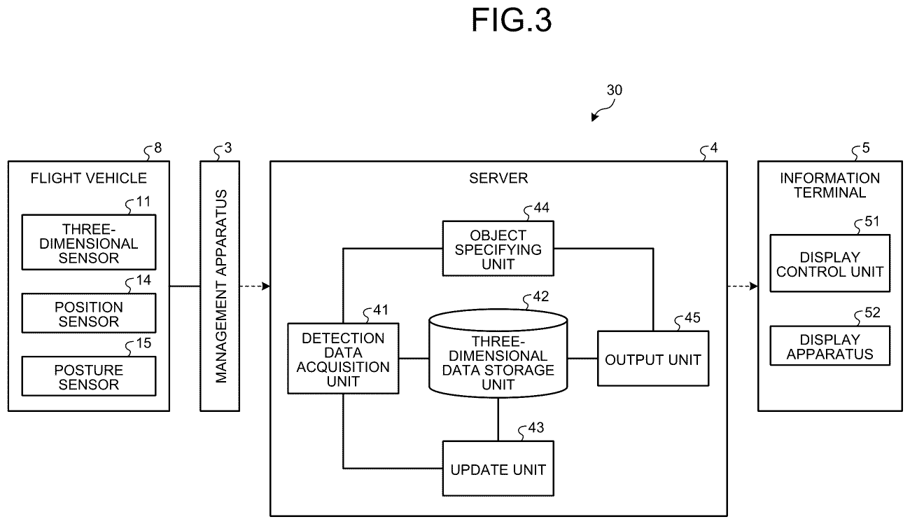

FIG. 3 is a functional block diagram illustrating a display system 30 according to the embodiment. As illustrated in FIG. 3, the display system 30 includes the flight vehicle 8, the management apparatus 3 disposed in the construction site 2, the server 4, and the information terminal 5 disposed in a remote location 9 of the construction site 2.

The flight vehicle 8 has the three-dimensional sensor 11, the position sensor 14, and the posture sensor 15.

The information terminal 5 has a display control unit 51 and a display apparatus 52.

The display apparatus 52 displays display data. A manager of the remote location 9 can confirm the display data displayed on the display apparatus 52. As the display apparatus 52, a flat panel display such as a liquid crystal display (LCD) or an organic electroluminescence display (OELD) is exemplified.

The server 4 has a detection data acquisition unit 41, a three-dimensional data storage unit 42, an update unit 43, an object specifying unit 44, and an output unit 45.

The detection data acquisition unit 41 acquires the detection data indicating the three-dimensional shape of the construction site 2 from the three-dimensional sensor 11. The detection data acquisition unit 41 acquires the three-dimensional data of the construction site 2 from the three-dimensional sensor 11. The detection data includes at least one of the topography of the construction site 2 and the work machine 20.

The three-dimensional data storage unit 42 stores the detection data acquired by the detection data acquisition unit 41. The three-dimensional data storage unit 42 stores three-dimensional data indicating a three-dimensional shape in a first range of the construction site 2.

The update unit 43 updates a partial range of the three-dimensional data stored in the three-dimensional data storage unit 42 on the basis of the detection data acquired by the detection data acquisition unit 41. In the embodiment, after the three-dimensional data indicating the three-dimensional shape in the first range of the construction site 2 is stored in the three-dimensional data storage unit 42, detection data indicating a three-dimensional shape in a second range that is a part of the first range is acquired by the detection data acquisition unit 41.

The object specifying unit 44 specifies an object in the image of the construction site 2 acquired by the detection data acquisition unit 41. As described above, the detection data of the three-dimensional sensor 11 includes image data indicating the image of the construction site 2. The object specifying unit 44 specifies the object using artificial intelligence (AI) that analyzes input data by an algorithm and outputs output data. The object specifying unit 44 specifies the object using, for example, a neural network.

The output unit 45 outputs the three-dimensional data updated by the update unit 43 to the information terminal 5. The output unit 45 transmits the three-dimensional data updated by the update unit 43 to the information terminal 5 via the communication system 10.

The output unit 45 transmits, to the display control unit 51, a control command for causing the display apparatus 52 to display the three-dimensional data updated by the update unit 43. As described above, the partial range of the three-dimensional data is updated. The output unit 45 transmits, to the display control unit 51, the control command for causing the display apparatus 52 to display the updated range and a non-updated range in different display forms in the three-dimensional data. On the basis of the control command transmitted from the output unit 45, the display control unit 51 controls the display apparatus 52 so that the updated range and the non-updated range in the three-dimensional data updated by the update unit 43 are displayed on the display apparatus 52 in different display forms.

### [Construction Management Method]

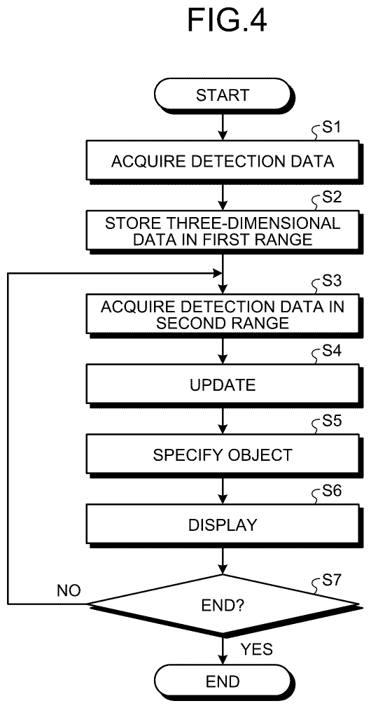

FIG. 4 is a flowchart illustrating a display method according to the embodiment.

When the flight vehicle 8 starts flying above the construction site 2, detection processing of the construction site 2 by the three-dimensional sensor 11 is started.

The detection data acquisition unit 41 acquires the detection data indicating the three-dimensional shape of the construction site 2 from the three-dimensional sensor 11 (step S1).

The three-dimensional data storage unit 42 stores the three-dimensional data indicating the three-dimensional shape in the first range of the construction site 2 acquired in step S1 (step S2).

The detection data acquisition unit 41 acquires the detection data indicating the three-dimensional shape in the second range of the construction site 2 from the three-dimensional sensor 11 (step S3).

The update unit 43 updates, on the basis of the detection data acquired in step S3, the partial range of the three-dimensional data stored in the three-dimensional data storage unit 42 in step S2 (step S4).

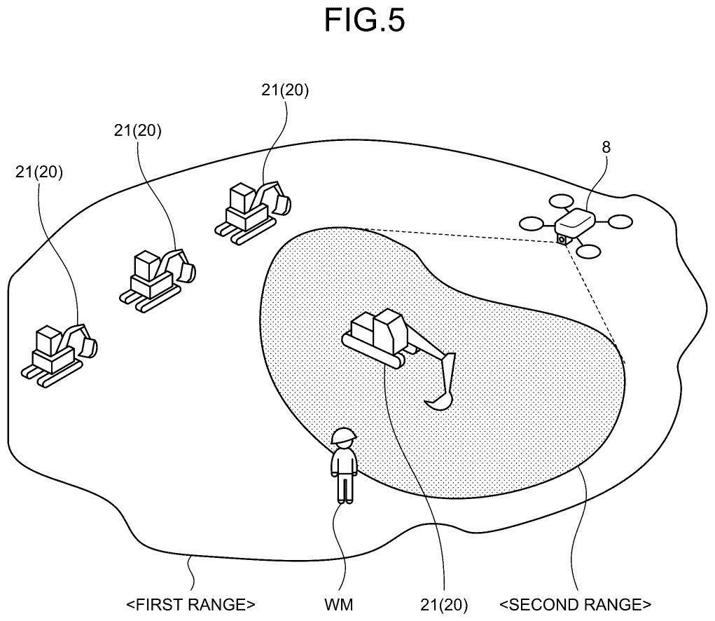

FIG. 5 is a diagram illustrating a relationship between the first range and the second range according to the embodiment. As illustrated in FIG. 5, the second range of the construction site 2 acquired in step S3 is smaller than the first range of the construction site 2 acquired in step S1. The second range is a part of the first range. The second range includes a range in which the situation of the construction site 2 has changed. The range outside the second range in the first range includes a range in which the situation of the construction site 2 has not changed.

In the construction site 2, there may be a dynamic range in which the situation changes and a static range in which the situation does not change. The dynamic range includes a range in which the situation of the topography of the construction site 2 changes due to a progress of construction and a range in which a situation of the hydraulic excavator 21 changes due to operation of the hydraulic excavator 21. The static range includes a range in which the construction does not progress and the situation of the topography of the construction site 2 does not change, and a range in which the hydraulic excavator 21 exists but the hydraulic excavator 21 does not operate and the situation of the hydraulic excavator 21 does not change. In step S3, the three-dimensional sensor 11 detects the second range, which is the dynamic range.

The update unit 43 updates a part of the three-dimensional data by replacing the partial range of the first range with the second range.

After the part of the three-dimensional data is updated by the update unit 43, the object specifying unit 44 specifies the object in the image of the construction site 2. The object specifying unit 44 specifies the object using the artificial intelligence (AI) (step S5).

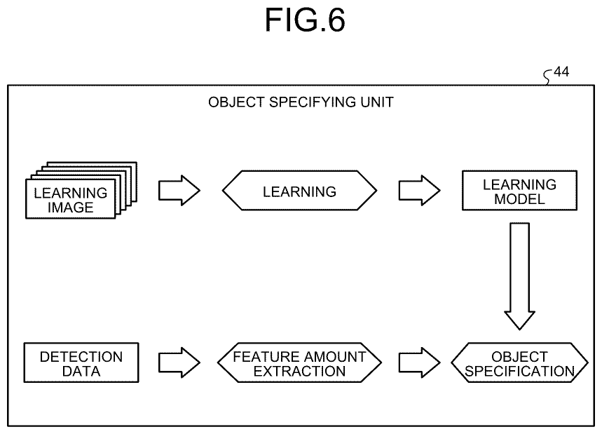

FIG. 6 is a diagram illustrating a method for specifying the object according to the embodiment. The object specifying unit 44 holds a learning model generated by learning a feature amount of the object. The object specifying unit 44 specifies the object from a two-dimensional image on the basis of the learning model. The object includes at least one of the person WM and the work machine 20. The object specifying unit 44 performs machine learning using, for example, a learning image including an image of a person and an image of a work machine as teacher data, thereby generating the learning model having the feature amount of the object as an input and a person or a work machine as an output. The object specifying unit 44 inputs, to the learning model, the feature amount of the object extracted from the image data indicating the image of the construction site 2 updated in step S4, and specifies the person WM or the work machine 20 in the two-dimensional image.

The output unit 45 transmits the three-dimensional data updated in step S4 and the object specified in step S5 to the information terminal 5 via the communication system 10. The output unit 45 transmits, to the display control unit 51, the control command for causing the display apparatus 52 to display the updated three-dimensional data. The display control unit 51 causes the display apparatus 52 to display the updated range and the non-updated range in the three-dimensional data in different display forms on the basis of the control command transmitted from the output unit 45 (step S6).

The output unit 45 determines whether or not to end the display of the three-dimensional data (step S7). When it is determined in step S7 that the display of the three-dimensional data is to be continued (step S7: No), the processing returns to step S3. As a result, the three-dimensional data indicating the three-dimensional shape of the construction site 2 is continuously updated. The display apparatus 52 displays display data in accordance with the situation of the construction site 2 in real time. When it is determined in step S7 that the display of the three-dimensional data is to be ended (step S7: Yes), the display of the three-dimensional data is ended.

### [Display Apparatus]

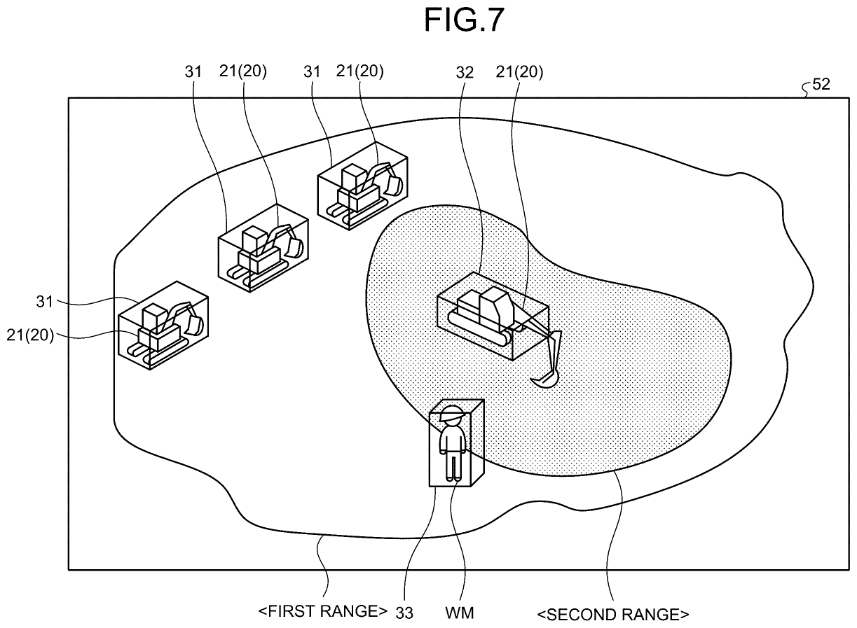

FIG. 7 is a view illustrating one example of the display apparatus 52 according to the embodiment. As illustrated in FIG. 7, the display control unit 51 causes the display apparatus 52 to display the updated range and the non-updated range in the three-dimensional data in different display forms. The updated range corresponds to the second range. The non-updated range corresponds to the range outside the second range in the first range. As illustrated in FIG. 7, the display control unit 51 may cause the display apparatus 52 to display the updated range and the non-updated range in different colors.

In addition, the display control unit 51 causes the display apparatus 52 to display the object specified by the object specifying unit 44 in a highlighted manner. As illustrated in FIG. 7, the display control unit 51 may cause a frame surrounding the object to be displayed. The object includes at least one of the person WM and the work machine 20. In the example illustrated in FIG. 7, the display control unit 51 causes the display apparatus 52 to display a frame 31 surrounding each of the hydraulic excavators 21 existing outside the second range in the first range. The display control unit 51 causes the display apparatus 52 to display a frame 32 surrounding the hydraulic excavator 21 existing in the second range. The display control unit 51 causes the display apparatus 52 to display a frame 33 surrounding the person WM. In addition, a three-dimensional model illustrating the object at a position of the object may be displayed. The three-dimensional model includes computer graphics (CG) of the object. For example, the three-dimensional model of the hydraulic excavator 21 may be displayed at the position of the hydraulic excavator 21 in the first range or the second range.

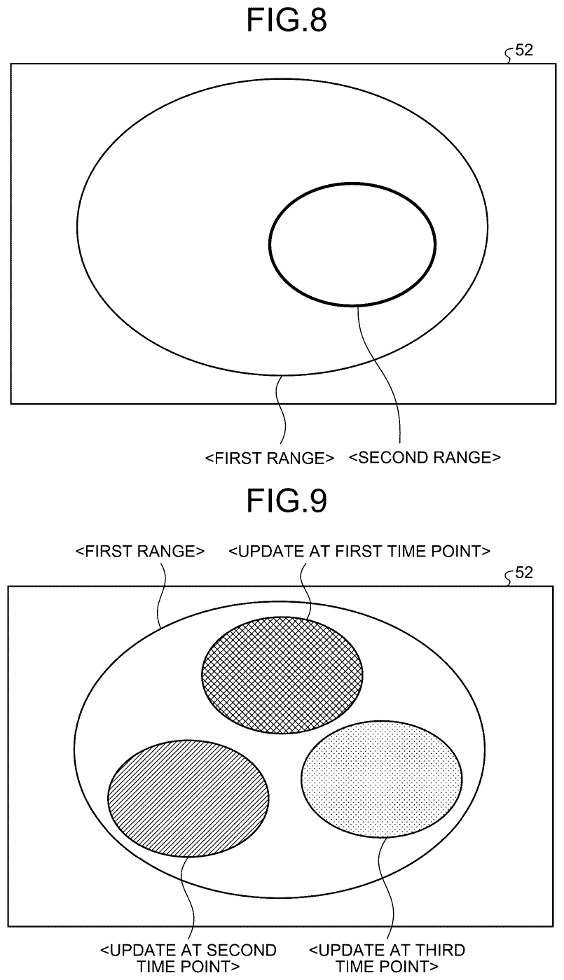

FIG. 8 is a diagram illustrating another example of the display apparatus 52 according to the embodiment. As illustrated in FIG. 8, the display control unit 51 may cause the display apparatus 52 to display the second range, which is the updated range, in a highlighted manner. For example, the display control unit 51 may cause the display apparatus 52 to display the second range so that the second range is surrounded by a thick line.

FIG. 9 is a diagram illustrating another example of the display apparatus 52 according to the embodiment. As illustrated in FIG. 4, the processing from step S3 to step S7 may be repeated a plurality of times. That is, the detection data acquisition unit 41 may acquire the detection data at each of a plurality of time points. The update unit 43 can update the three-dimensional data at each of the plurality of time points. The display control unit 51 may cause the display apparatus 52 to display the updated range in a display form different for each of the plurality of time points. As illustrated in FIG. 9, the display control unit 51 may cause the display apparatus 52 to display a range (second range) updated at a first time point, a range (second range) updated at a second time point after the first time point, and a range (second range) updated at a third point after the second time point in colors different from one another.

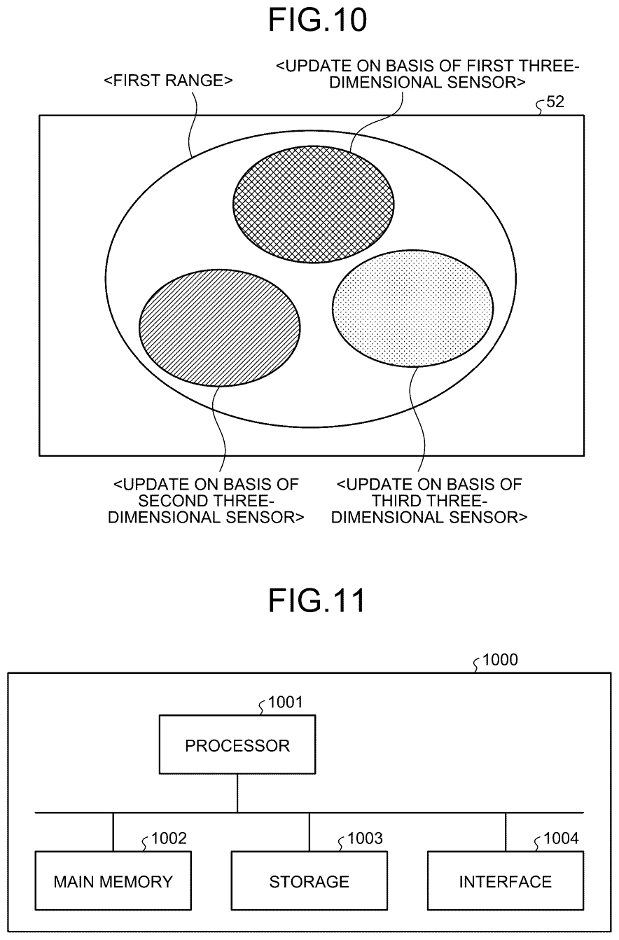

FIG. 10 is a diagram illustrating another example of the display apparatus 52 according to the embodiment. A plurality of three-dimensional sensors 11 may exist in the construction site 2, and each of the plurality of three-dimensional sensors 11 may detect the construction site 2. For example, a plurality of flight vehicles 8 in each of which the three-dimensional sensor 11 is disposed may fly over the construction site 2. The detection data acquisition unit 41 can acquire the detection data at each of the plurality of three-dimensional sensors 11. The update unit 43 can update the three-dimensional data on the basis of the detection data of each of the plurality of three-dimensional sensors 11. The display control unit 51 may cause the display apparatus 52 to display the updated range in a different display form for each of the plurality of three-dimensional sensors. As illustrated in FIG. 10, the display control unit 51 may cause the display apparatus 52 to display a range (second range) updated on the basis of detection data acquired by a first three-dimensional sensor 11, a range (second range) updated on the basis of detection data acquired by a second three-dimensional sensor 11, and a range (second range) updated on the basis of detection data acquired by a third three-dimensional sensor 11 in colors different from one another.

### [Computer System]

FIG. 11 is a functional block diagram illustrating a computer system 1000 according to the embodiment. The above-described server 4 includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The above-described function of the server 4 is stored in the storage 1003 as a computer program. The processor 1001 reads the computer program from the storage 1003, develops the computer program in the main memory 1002, and executes the above-described processing in accordance with the program. Note that the computer program may be distributed to the computer system 1000 via a network.

According to the above-described embodiment, the computer program or the computer system 1000 can execute: storing the three-dimensional data indicating the three-dimensional shape in the first range of the construction site 2 in which the work machine 20 operates; acquiring the detection data indicating the three-dimensional shape in the second range that is a part of the first range; updating the partial range of the three-dimensional data on the basis of the detection data; and causing the display apparatus to display the updated range and the non-updated range in different display forms in the three-dimensional data.

### [Effects]

As described above, according to the embodiment, when the situation of a part of the construction site 2 changes, only the changed part of the three-dimensional data of the construction site 2 stored in the three-dimensional data storage unit 42 is replaced with the latest detection data, and the three-dimensional data is updated. By displaying the updated three-dimensional data on the display apparatus 52, the manager can confirm the situation of the construction site 2 in real time. By confirming the situation of the construction site 2 in real time, the manager can grasp an area where the construction has progressed and an area where the construction needs to proceed. In addition, not all of the first range of the construction site 2 is replaced with the latest detection data, but only a changed part is replaced with the second range, which is the latest detection data, and thus appropriate three-dimensional data is displayed on the display apparatus 52. When it is attempted to replace the entire first range with the latest detection data, a load of update becomes large. By replacing only the changed part of the first range of the construction site 2 as the second range, the appropriate three-dimensional data is displayed on the display apparatus 52.

### OTHER EMBODIMENTS

In the above-described embodiment, after a part of the three-dimensional data is updated by the update unit 43, the object specifying unit 44 specifies the object in the image. The object specifying unit 44 may specify the object in the image at another time point. For example, before updating a part of the three-dimensional data, the object specifying unit 44 may specify the object in the image from the three-dimensional data indicating the three-dimensional shape in the first range and the detection data indicating the three-dimensional shape in the second range.

In the above-described embodiment, the flight vehicle 8 is a wired flight vehicle connected to the cable 7. The flight vehicle 8 may be a wireless flight vehicle that is not connected to the cable 7.

In the above-described embodiment, the position sensor 14 is used to detect the position of the flight vehicle 8, and the posture sensor 15 is used to detect the posture of the flight vehicle 8. Simultaneous localization and mapping (SLAM) may be used to detect the position and the posture of the flight vehicle 8. Geomagnetism or a barometer may be used to detect the position and the posture of the flight vehicle 8.

In the above-described embodiment, the object specifying unit 44 may specify the object on the basis of, for example, a pattern matching method without using artificial intelligence. The object specifying unit 44 can specify the object by collating a template indicating the object with the image data of the construction site 2.

In the above-described embodiment, the management apparatus 3 is supported by the traveling apparatus 6 and can travel in the construction site 2. The management apparatus 3 may be mounted on the work machine 20 or may be installed at a predetermined position in the construction site 2.

In the above-described embodiment, the information terminal 5 may not be disposed at the remote location 9 of the construction site 2. The information terminal 5 may be mounted on the work machine 20, for example.

In the above-described embodiment, each of the display control unit 51 and the display apparatus 52 is included in the information terminal 5. Each of the display control unit 51 and the display apparatus 52 may be included in a control apparatus of the work machine 20. Further, when the work machine 20 is remotely operated, each of the display control unit 51 and the display apparatus 52 may be included in a control apparatus installed at a remote location where the work machine 20 is remotely operated.

In the above-described embodiment, the function of the server 4 may be provided in the management apparatus 3, in the information terminal 5, or in a computer system mounted on the flight vehicle 8. For example, at least one function of the detection data acquisition unit 41, the three-dimensional data storage unit 42, the update unit 43, the object specifying unit 44, and the output unit 45 may be provided in the management apparatus 3, in the information terminal 5, or in the computer system mounted on the flight vehicle 8.

In the above-described embodiment, each of the detection data acquisition unit 41, the three-dimensional data storage unit 42, the update unit 43, the object specifying unit 44, and the output unit 45 may be configured by different hardware.

In the above-described embodiment, the three-dimensional sensor 11 may not be disposed in the flight vehicle 8. The three-dimensional sensor 11 may be disposed, for example, in the work machine 20 or in the traveling apparatus 6. Further, the three-dimensional sensor 11 may be disposed in a moving body different from the flight vehicle 8, the work machine 20, and the traveling apparatus 6. The three-dimensional sensor 11 may be disposed in a structure existing in the construction site 2. In addition, a plurality of three-dimensional sensors 11 may be installed in the construction site 2, and the construction site 2 may be detected over a wide range.

In the above-described embodiment, the object includes at least one of the person WM and the work machine 20. The object may include at least one of construction tools, wood, or materials.

In the above-described embodiment, the display control unit 51 may cause the display apparatus 52 to display the updated range and the non-updated range on in different display forms in color brightness, transparency, or luminance. In addition, the display control unit 51 may cause the display apparatus 52 to display the range (second range) updated at the first time point, the range (second range) updated at the second time point after the first time point, and the range (second range) updated at the third time point after the second time point so that the display forms are different from one another in color brightness, transparency, or brightness. Furthermore, the display control unit 51 may cause the display apparatus 52 to display the range (second range) updated on the basis of detection data acquired by the first three-dimensional sensor 11, the range (second range) updated on the basis of detection data acquired by the second three-dimensional sensor 11, and the range (second range) updated on the basis of detection data acquired by the third three-dimensional sensor 11 in display forms different from one another in color brightness, transparency, or luminance.

In the above-described embodiment, the work machine 20 may be a work machine different from the hydraulic excavator 21, the bulldozer 22, and the crawler dump 23. The work machine 20 may include, for example, a wheel loader.

### REFERENCE SIGNS LIST

1 CONSTRUCTION MANAGEMENT SYSTEM
2 CONSTRUCTION SITE
3 MANAGEMENT APPARATUS
4 SERVER (DATA PROCESSING APPARATUS)
5 INFORMATION TERMINAL
6 TRAVELING APPARATUS
7 CABLE
8 FLIGHT VEHICLE
9 REMOTE LOCATION
10 COMMUNICATION SYSTEM
11 THREE-DIMENSIONAL SENSOR
14 POSITION SENSOR
15 POSTURE SENSOR
20 WORK MACHINE
21 HYDRAULIC EXCAVATOR
22 BULLDOZER
23 CRAWLER DUMP
30 DISPLAY SYSTEM
31 FRAME
32 FRAME
33 FRAME
41 DETECTION DATA ACQUISITION UNIT
42 THREE-DIMENSIONAL DATA STORAGE UNIT
43 UPDATE UNIT
44 OBJECT SPECIFYING UNIT
45 OUTPUT UNIT
51 DISPLAY CONTROL UNIT
52 DISPLAY APPARATUS
1000 COMPUTER SYSTEM
1001 PROCESSOR
1002 MAIN MEMORY
1003 STORAGE
1004 INTERFACE
WM PERSON

1. A display system comprising:
a three-dimensional data storage unit that stores three-dimensional data indicating a three-dimensional shape in a first range of a construction site in which a work machine operates;
a detection data acquisition unit that acquires detection data indicating a three-dimensional shape in a second range that is a part of the first range;
an update unit that updates a partial range of the three-dimensional data on the basis of the detection data; and
a display control unit that causes a display apparatus to display an updated range and a non-updated range in different display forms in the three-dimensional data.

2. The display system according to claim 1,
wherein the display control unit causes the updated range and the non-updated range to be displayed in different colors.

3. The display system according to claim 1,
wherein the display control unit causes the updated range to be displayed in a highlighted manner.

4. The display system according to claim 1,
wherein the detection data includes image data indicating an image of the construction site,
the display system comprises an object specifying unit that specifies an object in the image, and
the display control unit causes the specified object to be displayed in a highlighted manner.

5. The display system according to claim 4,
wherein the display control unit causes a frame surrounding the object to be displayed.

6. The display system according to claim 4,
wherein the object includes at least one of a person and the work machine.

7. The display system according to claim 1,
wherein the detection data acquisition unit acquires the detection data at each of a plurality of time points,
the update unit updates the three-dimensional data at each of the plurality of time points, and
the display control unit causes the updated range to be displayed in different display forms for each of the plurality of time points.

8. The display system according to claim 1,
wherein the detection data acquisition unit acquires the detection data from a three-dimensional sensor that detects the construction site, and
the three-dimensional sensor is disposed on a moving body.

9. The display system according to claim 8,
wherein the moving body includes at least one of a flight vehicle and the work machine.

10. The display system according to claim 8,
wherein the detection data acquisition unit acquires the detection data from each of a plurality of three-dimensional sensors,
the update unit updates the three-dimensional data on the basis of the detection data of each of the plurality of three-dimensional sensors, and
the display control unit causes the updated range to be displayed in different display forms for each of the plurality of three-dimensional sensors.

11. A display method comprising:
storing three-dimensional data indicating a three-dimensional shape in a first range of a construction site in which a work machine operates;
acquiring detection data indicating a three-dimensional shape in a second range that is a part of the first range;
updating a partial range of the three-dimensional data on the basis of the detection data; and
causing a display apparatus to display an updated range and a non-updated range in different display forms in the three-dimensional data.

12. The display method according to claim 11,
wherein the updated range and the non-updated range are displayed in different colors.

13. The display method according to claim 11,
wherein the updated range is displayed in a highlighted manner.

14. The display method according to claim 11,
wherein the detection data includes image data indicating an image of the construction site,
the method comprises specifying an object in the image, and
the specified object is displayed in a highlighted manner.

15. The display method according to claim 14,
wherein a frame surrounding the object is displayed.

16. The display method according to claim 14,
wherein the object includes at least one of a person and the work machine.

17. The display method according to claim 11,
wherein the detection data is acquired at each of a plurality of time points,
the three-dimensional data is updated at each of the plurality of time points, and
the updated range is displayed in different display forms for each of the plurality of time points.

18. The display method according to claim 11,
wherein the detection data is acquired from a three-dimensional sensor that detects the construction site, and
the three-dimensional sensor is disposed on a moving body.

19. The display method according to claim 18,
wherein the moving body includes at least one of a flight vehicle and the work machine.

20. The display method according to claim 18,
wherein the detection data is acquired from each of a plurality of three-dimensional sensors,
the three-dimensional data is updated on the basis of the detection data of each of the plurality of three-dimensional sensors, and
the updated range is displayed in different display forms for each of the plurality of three-dimensional sensors.
